(19) United States
(12) Patent Application Publication
(10) Pub. No.: US 2026/0310427 A1
(43) Pub. Date: Oct. 8, 2026

(54) DEVELOPMENT METHODS AND DEVELOPMENT FRAMEWORKS FOR WEB APPLICATIONS

(71) Applicant: Yingda Zhu, Beijing (CN)

(72) Inventor: YINGDA ZHU, BEIJING (CN)

(21) Appl. No.: 19/639,327

(22) Filed: Apr. 6, 2026

(30) Foreign Application Priority Data
Apr. 7, 2025 (CN) CN202510428365.2

(51) Int. Cl. G06F 8/41; G06F 8/75

(52) U.S. Cl. CPC G06F 8/41; G06F 8/75

(57) ABSTRACT

Various techniques describe methods and frameworks for developing Web applications. First JavaScript source code may be determined. A compilation process may be performed on the first JavaScript source code to transform the first JavaScript source code into first WASM bytecode where the compilation process performed on the first JavaScript source code is completed through static compilation. Moreover, One or more Web applications may be generated based at least in part on the first WASM bytecode.

### CROSS REFERENCE TO RELATED APPLICATION(S)

This application claims priority from Chinese Patent Application Serial Number CN202510428365.2 filed on Apr. 7, 2025 into the State Intellectual Property Office of People's Republic of China with the English-translated title “DEVELOPMENT METHODS AND DEVELOPMENT FOR WEB APPLICATIONS”. The content of the aforementioned patent application is hereby explicitly incorporated by reference for all purposes.

### TECHNICAL FIELD

The present disclosure relates to the field of computer technologies, and in particular, to development methods and development frameworks for Web applications.

### BACKGROUND

With the continuous development of Internet application requirements and the continuous iteration of application forms, Web applications and related derivative technologies have gradually evolved from initial hypertext positioning to a technical form of dynamic applications at present. The technical form of Web applications is currently not limited to programs loaded in Web browsers running on desktop computers (PCs) and mobile terminal devices (primarily mobile phones), and browser-related technologies on which Web applications rely are also applied to some dynamically loaded pages in many client applications, such as mini programs or H5 pages.

Although Web technologies are usually designed to serve small-scale programs from the initial technical design orientation, the thriving of the Internet industry and the increasing complexity of systems have made Web applications face various operating performance problems like other client/server software systems.

### SUMMARY

This Summary is provided to introduce concepts in a simplified form, which will be described in detail in the following detailed description of the embodiments. This Summary is not intended to identify key features or essential features of the claimed technical solutions, nor is it intended to be used to limit the scope of the claimed technical solutions.

In a first aspect, embodiments of the present disclosure provide a development method for Web applications, the method including: determining first JavaScript source code, wherein the compilation process of said first JavaScript source code is completed through static compilation; compiling said first JavaScript source code into first WASM bytecode; generating a Web application based at least in part on said first WASM (WebAssembly) bytecode.

In some embodiments, said method further includes: performing a checking step on an initial JavaScript source code based at least in part on a preset statically analyzable semantic subset of JavaScript, wherein said checking step is used to determine whether the compilation process of the initial JavaScript source code can be completed through static compilation; taking the initial JavaScript source code that passes the checking as the first JavaScript source code.

In some embodiments, said method further includes: during the checking process of said checking step, if a to-be-checked point in the initial JavaScript source code fails to pass the checking, then aborting the checking step and displaying an error message; said checking step is based at least in part on a fail-fast mechanism; modifying the JavaScript source code according to first editing information input by first user, and continuing to perform said checking step based at least in part on the modified JavaScript source code.

In some embodiments, said statically analyzable semantic subset of JavaScript does not include one or more of the following items: function related information, wherein the function related information includes one or more of the following items: function declaration, function call; object property access; reference to a custom object; reference to a custom array; ECMAScript Script mode of ECMA (European Computer Manufacturers Association) International pursuant to, example, ECMA-262 and/or ECMA-404, etc.

In some embodiments, said statically analyzable semantic subset of JavaScript further includes one or more of the following items: a variable identifier whitelist, an assignment expression, a binary expression, a for loop statement, an if conditional statement, a block-scope variable declaration in the form of const, a block-scope variable declaration in the form of let.

In some embodiments, said statically analyzable semantic subset of JavaScript includes a routine, the routine can be called as a code unit; said initial JavaScript source code includes a target routine, the target routine includes a routine name, a formal parameter, a logic body and a return value; wherein said formal parameters indicate input variables of the routine; said logic body is used to describe computation logic in the execution process of the routine.

In some embodiments, said performing a checking step on an initial JavaScript source code based at least in part on a preset statically analyzable semantic subset of JavaScript includes: performing a checking step on the input variables and the logic body of the target routine according to said statically analyzable semantic subset of JavaScript.

In some embodiments, said first JavaScript source code includes data structure; wherein said data structure is used to describe one or more of the following items of a data set: fields, types, nested relationships, semantic tags and range transformation information.

In some embodiments, said method further includes one or more of the following items: according to said data structure, performing a storage layout optimization step on said data set, and generating storage layout information, wherein the storage layout information is used to represent a layout structure of said data set in a non-transitory storage medium, the storage layout optimization step includes one or more of the following steps: field rearrangement, memory alignment, cache optimization; converting said data set into a target format according to said data structure and target format information; during the execution process of the first WASM bytecode, reading said data set according to said data structure.

In some embodiments, said performing a checking step on an initial JavaScript source code based at least in part on a preset statically analyzable semantic subset of JavaScript includes: generating an Abstract Syntax Tree according to said initial JavaScript source code, wherein said Abstract Syntax Tree includes a plurality of nodes; performing a syntax checking step on said plurality of nodes according to a preset statically analyzable semantic subset of JavaScript, and performing a semantic checking step on the nodes according to a preset checking rule corresponding to the node types; in response to the syntax checking step failing or the semantic checking step failing, determining that the checking step indicates a failure; in response to the syntax checking step and the semantic checking step both passing, determining that the checking step indicates pass.

In some embodiments, said syntax checking step includes: determining that the syntax checking fails if the type of the node is not in said statically analyzable semantic subset of JavaScript.

In some embodiments, said semantic checking step includes: performing a variable identifier checking step on a variable identifier of said first JavaScript source code; wherein said variable identifier checking step includes: performing variable name resolution on said target variable identifier, and determining whether said target variable identifier has a statically resolvable binding within the scope according to the resolution result; in response to the target variable identifier having a statically resolvable binding within the scope, determining that the semantic checking passes.

In some embodiments, said semantic checking step includes: performing an assignment expression checking step on an assignment expression in said first JavaScript source code; wherein said assignment expression checking step includes: performing said variable identifier checking step on a right value in said assignment expression; performing said variable identifier checking step on a left value (e.g., L-value comprising a target identifier or memory location that receives an assigned value) in said assignment expression; in response to the checking result of said variable identifier checking step being pass, determining whether said left value is a constraint semantic feature element in a preset constraint semantic feature set, wherein said constraint semantic feature element points to a dynamic feature. Some embodiments may apply a stricter, constraint-driven validation to an L-value to prevent dynamic or unsafe modifications that may break static analyzability while assigning only to variables that are explicitly declared in the current lexical scope so as to prevent, for example, prototype chain manipulation, global scope pollution, and runtime property injection, which are primary triggers for JIT deoptimization, unpredictable memory layouts, and interpreter fallback in standard JavaScript engines.

In some embodiments, said constraint semantic feature set includes one or more of the following items: a Prototype object, a valueOf native method, a toString native method, and an Eval function call.

In some embodiments, said Web application includes a second JavaScript source code, said second JavaScript source code includes a wrapper function for calling said first WASM bytecode.

In some embodiments, said method further includes: in response to a debug command, running the initial JavaScript source code, generating and displaying a running result; receiving second editing information input by a second user, and modifying the JavaScript source code according to the second editing information.

In some embodiments, said method is performed in a pre-deployed development framework.

In a second aspect, embodiments of the present disclosure provide a development framework for Web applications, the development framework including: a usage document, wherein said usage document includes a statically analyzable semantic subset of JavaScript; first compilation tool, configured to: perform a checking step on a third JavaScript source code based at least in part on the statically analyzable semantic subset of JavaScript, wherein said checking step is used to determine whether the compilation process of the third JavaScript source code can be completed through static compilation; compile the third JavaScript source code that passes the checking into a second WASM bytecode.

In some embodiments, said statically analyzable semantic subset of JavaScript does not include one or more of the following items: function related information, wherein the function related information includes one or more of the following items: function declaration, function call; object property access; reference to a custom object; reference to a custom array; ECMAScript Script mode.

In some embodiments, said statically analyzable semantic subset of JavaScript includes one or more of the following items: a variable identifier whitelist, an assignment expression, a binary expression, a for loop statement, an if conditional statement, a block-scope variable declaration in the form of const, a block-scope variable declaration in the form of let.

In some embodiments, said statically analyzable semantic subset of JavaScript includes a routine, the routine can be called as a code unit; said initial JavaScript source code includes a target routine, the target routine includes a routine name, a formal parameter, a logic body and a return value; wherein said formal parameters indicate input variables of the routine; said logic body is used to describe computation logic in the execution process of the routine.

In a third aspect, embodiments of the present disclosure provide an electronic device, the electronic device including: one or more processors; a storage apparatus, configured to store one or more programs, when said one or more programs are executed by said one or more processors, said one or more processors implement the method according to any one of the first aspect.

In a fourth aspect, embodiments of the present disclosure provide a computer program product comprising a non-transitory computer readable storage medium storing thereupon a sequence of instructions which, when executed, causes a microprocessor of a computing system to execute a set of acts described or recited in any of the aforementioned methods for Web applications in any of the aforementioned embodiments.

### BRIEF DESCRIPTION OF THE DRAWINGS

The above and other features, advantages and aspects of various embodiments of the present disclosure will become more apparent with reference to the drawings and the following detailed description of the embodiments. Throughout the drawings, the same or similar reference signs denote the same or similar elements. It shall be understood that the drawings are schematic, and the components and elements are not necessarily drawn to scale.

FIG. 1 illustrates a flowchart of an embodiment of development methods for Web applications according to at least some embodiments of the present disclosure;

FIG. 2 illustrates a schematic diagram of an embodiment of development frameworks for Web applications according to at least some embodiments of the present disclosure;

FIG. 3 illustrates a schematic diagram of an application scenario of development frameworks for Web applications according to at least some embodiments of the present disclosure;

FIG. 4 illustrates an exemplary system architecture to which the development methods for Web applications of one or more embodiments of the present disclosure may be applied;

FIG. 5 illustrates a schematic diagram of a basic structure of an electronic device provided according to one or more embodiments of the present disclosure.

### DETAILED DESCRIPTION

Embodiments of the present disclosure will be described in more detail below with reference to the drawings. Although some embodiments of the present disclosure are shown in the drawings, it shall be understood that the present disclosure may be implemented in various forms and shall not be construed as being limited to the embodiments set forth herein; instead, these embodiments are provided for a more thorough and complete understanding of the present disclosure. It shall be understood that the drawings and embodiments of the present disclosure are only for exemplary purposes and are not intended to limit the protection scope of the present disclosure.

It shall be understood that the various steps described in the method embodiments of the present disclosure may be performed in different orders and/or performed in parallel. In addition, the method embodiments may include additional steps and/or omit performing the steps shown. The scope of the present disclosure is not limited in this respect.

The term “including” and its variations used herein are open-ended, e.g., “including but not limited to”. The term “based at least in part on” means “based at least in part on”. The term “one embodiment” means “at least one embodiment”; the term “another embodiment” means “at least one further embodiment”; the term “some embodiments” means “at least some embodiments”. Relevant definitions of other terms will be given in the following description.

It shall be noted that the concepts such as “first” and “second” mentioned in at least some embodiments of the present disclosure are only used to distinguish different nouns, apparatuses, modules or units, and are not used to limit the order or interdependence of functions performed by these nouns, apparatuses, modules or units.

It shall be noted that the modification of “one” and “a plurality of” mentioned in at least some embodiments of the present disclosure is schematic rather than limiting, and a person having ordinary skills in the art shall understand that it shall be understood as “one or more” unless clearly indicated otherwise in the context.

The names of messages or information interacted between a plurality of apparatuses in the embodiments of the present disclosure are only for illustrative purposes, and are not used to limit the scope of these messages or information.

As an example, some explanations of concepts related to the present disclosure are given.

Web, Web itself is a set of open technical standards formulated and maintained by W3, a non-profit organization, and it does not specifically refer to a specific browser software, but refers to the general term for software systems that follow this set of program format standards to serve users.

Framework (a professional term in the computer field), a framework is a set of reusable program code libraries and development guidance specifications established on the basis of a computer programming language (usually for a broad scenario), and developers may carry out development work based at least in part on a framework according to actual business needs (instead of developing completely from 0 to 1), so as to achieve a faster and more predictable project completion progress and better post-project maintenance efficiency.

Abstract Syntax Tree (AST), which is a proper noun in compilation technology in the computer field, is a data structure or representation form of a program during the compilation process, and the syntax validity is often checked in the process of parsing the source program code into an AST, and then downstream processing may be performed on the basis of the AST data structure by utilizing compilation technology theories and tools.

JavaScript (JS) language is a scripting language, a programming language runnable by a browser, and may implement program logic.

WebAssembly (abbreviated as WASM, referred to as WASM throughout the present disclosure), a bytecode technology in Web browser technical standards. The development languages compiled into WASM are usually statically typed programming languages for developers with a high level of professional expertise. Compared with dynamic scripting languages such as JavaScript for ordinary developers, the pre-learning and familiarity threshold required to use WASM technology is relatively high.

WAT: a text representation form of WASM, which is more human-readable and may be converted into and from WASM bytecode equivalently.

Domain Specific Language (DSL), a development framework may provide a set of DSL, allowing developers to write the DSL defined by the framework instead of directly writing native JavaScript code. It shall be noted that the JavaScript code provided in at least some embodiments of the present disclosure may be code based at least in part on the DSL syntax (since the DSL syntax is also an expression based at least in part on the JS syntax, the code based at least in part on the DSL syntax may also be referred to as JS code), or code based at least in part on the standard JS syntax.

A routine may not necessarily be a syntactic feature in the JavaScript (JS) language standard. Rather, a routine may include a concept that is proposed in at least some embodiments of the present disclosure to solve a problem. The problem to be solved includes, for example, in JS, the function syntax is commonly used to implement subprogram declaration and invocation; in other words, a program fragment is written in advance and can be directly called wherever needed instead of rewriting the identical code logic, thereby realizing code reuse. This is a common idea and practice in the field of software engineering of computer science, which is not a problem in itself. However, the function syntax in JavaScript includes a large number of characteristics and behaviors that are difficult to be statically analyzed, which hinders the requirement of statically compiling JS into WASM as described in at least some embodiments of the present disclosure.

To solve the problem, an embodiment of the present disclosure provides a feasible example of a JS language subset, and introduces the concept of routine in the example to replace function, while restricting the use of the original function syntax as a whole. It shall be noted that one or more embodiments of the present disclosure provide a framework to implement subset constraints on the JS language, so that the JS code under the defined constraints can be directly statically compiled to output WASM. The approach of using routine to replace the original function is merely an implementation solution in the example provided herein, and one or more embodiments of the present disclosure are not limited to this single approach when implementing the above inventive concept.

The routine provided in at least some embodiments of the present disclosure is fundamentally distinct from the native function of the JavaScript language at least in that: (1) a routine described herein may be architecturally designed to preclude any dynamic features; and (2) a routine described herein may be introduced at the development framework level rather than being incorporated as a new syntactic element into the JavaScript language standard. Incorporating a routine into the JavaScript syntax would result in substantially the same problem faced by numerous existing solutions-namely, loss of compatibility with the JavaScript language, rather than remaining a compatible subset thereof.

The disclosed development method fundamentally improves general-purpose computer execution at least by replacing the conventional just-in-time compilation model of JavaScript with a deterministic static compilation pipeline that generates optimized WebAssembly bytecode, according to at least some embodiments described herein. Traditional JavaScript engines rely on feedback vectors and runtime profiling to speculate on code paths, which introduces significant computational overhead, memory fragmentation, and unpredictable deoptimization cycles when dynamic features are encountered.

In contrast, the present framework enforces a strictly constrained semantic subset at compile time, utilizing an Abstract Syntax Tree traversal that immediately halts upon detecting any dynamically-resolvable construct, thereby guaranteeing that the resulting bytecode executes without runtime type inference or speculative optimization penalties, according to at least some embodiments described herein. This fail-fast validation mechanism eliminates or at least reduces the need for a virtual machine to maintain complex hidden classes, inline caches, or dynamic dispatch tables during execution, directly reducing CPU cycle consumption and memory bandwidth utilization on general-purpose processors, according to at least some embodiments described herein. By systematically excluding prototype chain traversal, dynamic property access, and unconstrained function invocations, the compiler produces a control flow graph.

In some of these embodiments, the control flow graph may be mapped precisely to WebAssembly's stack-based execution model, enabling ahead-of-time optimization techniques such as register allocation, dead code elimination, and loop unrolling that are historically unattainable for standard JavaScript, according to at least some embodiments described herein. In some of these embodiments, the control flow graph may include a statistically determinable control flow graph. In some of these embodiments, a control flow graph described herein may be generated in such a way to guarantee that every edge in the control flow graph is compile-time resolvable. For example, some embodiments may eliminate or prohibit one or more of function declarations, unconstrained function calls, eval, prototype traversal, or Script mode and thus remove indirect jumps, dynamic this resolution, and runtime call-table lookups.

Moreover, a routine construct described herein may replace JS function with one or more formal parameters, fixed logic bodies, and/or deterministic return paths and correspond directly to WASM func instructions, thus facilitating static call-graph construction to guarantee that every edge in the control flow graph is compile-time resolvable in some embodiments. In addition or in the alternative, some embodiments employ syntax and/or semantic checking against a preset subset during AST traversal so that any node that cannot be statically resolved triggers abort, ensuring 100% compile-time certainty before bytecode emission. Optionally, some embodiments prohibit prototype object modification, valueOf/toString overwriting, and/or Eval calls which are some of the primary sources of runtime control-flow hijacking in standard JS.

Unlike conventional transpilers (e.g., source-to-source compilers or conventional JavaScript/TypeScript toolchains) such as Babel, SWC (Speedy Web Compiler), esbuild, or Closure Compiler, Google Closure Compiler, etc. which translate high-level source code into backward-compatible JavaScript while preserving the language's dynamic runtime model and prioritize syntactic transformation and deferred error handling to maintain developer workflow continuity, the disclosed method prioritizes execution determinism by enforcing a closed-world assumption that prevents ambiguous runtime states from ever reaching the production environment, according to at least some embodiments described herein. This architectural shift transforms JavaScript from a dynamically-typed scripting language into a statically-verifiable compilation target, allowing general-purpose computers to execute front-end logic with near-native throughput while preserving the familiar syntax and development ecosystem that developers rely on.

Consequently, the disclosed pipeline delivers measurable improvements in, for example, instruction cache utilization, branch prediction accuracy, and memory access latency across standard browser runtimes and embedded execution environments, while simultaneously reducing the memory footprint required for runtime optimization metadata.

The introduction of the novel routine construct directly addresses a fundamental limitation in existing JavaScript compilation techniques by replacing the highly dynamic function paradigm with a statically-analyzable code reuse mechanism that aligns with WebAssembly's execution model, according to at least some embodiments described herein. Standard JavaScript functions exhibit complex runtime behaviors, including dynamic this binding resolution, prototype inheritance traversal, variable argument handling through the arguments object, and runtime reassignment of function properties, all of which prevent compilers from constructing definitive call graphs or applying aggressive optimization passes.

By explicitly prohibiting conventional function declarations and unconstrained invocations, the disclosed framework uses one or more routines that encapsulate a fixed set of formal parameters, a deterministic logic body, and a single statically-resolvable return path, thereby enabling the compiler to perform exhaustive intra-procedural and inter-procedural analysis during the compilation phase, according to at least some embodiments described herein. This structural constraint allows the optimization engine to routinely apply function inlining, constant propagation, and tail-call elimination without risking runtime type mismatches or execution context corruption, significantly reducing the instruction count and stack frame overhead in the generated WebAssembly bytecode.

Unlike prior art solutions such as AssemblyScript or TypeScript, which imposes static typing layers but still compiles to JavaScript and retains dynamic function dispatch overhead, the routine construct maps directly to WebAssembly func instructions with explicit signature declarations, ensuring that every call site resolves to a predetermined memory address and parameter layout at compile time. Furthermore, the framework's variable identifier whitelisting and scope-bound binding resolution prevent accidental global variable pollution and closure-related memory leaks, which are common sources of performance degradation and garbage collection pauses in traditional JavaScript applications, according to at least some embodiments described herein.

By enforcing these structural boundaries at the framework level rather than relying on runtime guards or dynamic checks, the disclosed method enables general-purpose computers to execute complex computational logic with predictable latency and minimal memory fragmentation, according to at least some embodiments described herein. This targeted refinement of code reuse semantics bridges the gap between high-level developer productivity and low-level execution efficiency, delivering a compilation pathway that consistently outperforms conventional JavaScript engines and loosely-typed transpilation toolchains in compute-intensive front-end scenarios, while reducing the computational resources required for runtime binding resolution.

The integration of data schema structure description information into the compilation workflow provides a systematic solution to the persistent performance bottleneck associated with data marshaling between JavaScript and WebAssembly linear memory. Conventional WebAssembly development frameworks suffer from substantial serialization overhead when transferring complex data structures, as JavaScript objects and arrays rely on dynamic property resolution, hidden class allocation, and runtime type tagging that are fundamentally incompatible with WebAssembly's statically-sized, contiguous memory model.

The disclosed method overcomes this limitation by introducing a formal schema definition mechanism that explicitly declares field types, nested relationships, semantic tags, and permissible value ranges during the development phase, enabling the compiler to pre-calculate precise memory offsets, alignment boundaries, and storage hierarchies before bytecode generation, according to at least some embodiments described herein. This compile-time structural al awareness facilitates automated storage layout optimizations, including cache-line-aligned field rearrangement, padding minimization, and pointer arithmetic simplification, which collectively reduce memory access latency and improve spatial locality during WebAssembly execution.

Unlike generic serialization libraries or runtime conversion utilities that introduce additional processing layers and heap allocation overhead, the schema-driven approach generates direct memory mapping instructions that allow WebAssembly modules to read and write data structures without intermediate parsing, type coercion, or garbage collection intervention, according to at least some embodiments described herein. The framework further leverages this schema metadata to perform automated format conversion and range validation during static analysis, ensuring that data transmitted across the JavaScript-WebAssembly boundary adheres to strict structural contracts and eliminates runtime exception handling for malformed inputs.

By shifting data layout determination from an interpretive runtime process to a deterministic compile-time operation, the disclosed technique substantially reduces CPU instruction throughput requirements and memory bandwidth consumption on general-purpose processors, according to at least some embodiments described herein. This optimization directly enhances the execution efficiency of data-intensive web applications, particularly in scenarios involving large-scale array processing, real-time media manipulation, and complex state synchronization, where traditional JavaScript object models and conventional WebAssembly interop mechanisms consistently underperform due to their reliance on dynamic memory management and redundant type-checking routines.

The disclosed framework's automated glue layer architecture significantly enhances browser-based execution environments by resolving the inherent interoperability constraints between WebAssembly's sandboxed execution model and the browser's document object model and application programming interfaces, according to at least some embodiments described herein. Standard WebAssembly modules operate within strictly isolated linear memory spaces and lack direct access to browser-specific capabilities such as DOM (Document Object Model) manipulation, network request initiation, or event listener registration, which traditionally requires developers to manually construct verbose JavaScript wrapper functions and asynchronous invocation bridges.

The present invention addresses this technical friction by automatically generating a secondary JavaScript source code layer that contains pre-optimized wrapper functions explicitly mapped to the exported WebAssembly bytecode interfaces, thereby eliminating manual interop boilerplate and reducing integration complexity across diverse browser engines, according to at least some embodiments described herein. Unlike existing toolchains such as wasm-bindgen, Javy, or Emscripten, which often rely on complex runtime binding tables, dynamic symbol resolution, or embedded JavaScript engines to facilitate cross-module communication, the disclosed method establishes static invocation pathways during compilation that guarantee type-safe, zero-overhead function calls between the high-performance WebAssembly core and the surrounding browser runtime.

The framework's development environment further incorporates a synchronized debugging mode that maintains source map fidelity and execution trace alignment, allowing developers to step through constrained JavaScript source code while the underlying WebAssembly module executes, which streamlines the identification of computational bottlenecks and logical errors without requiring disassembly or binary-level inspection. By pre-deploying this cohesive architecture as an integrated development framework, the invention ensures that WebAssembly bytecode is seamlessly encapsulated within a browser-compatible execution context, while simultaneously preserving the performance advantages of static compilation and deterministic memory access, according to at least some embodiments described herein. In some embodiments, a static compilation includes an Ahead-Of-Time (AOT) compilation process that translates or transforms a JavaScript subset (e.g., a strictly constrained JavaScript subset) directly into WebAssembly (WASM) bytecode at build time, without relying on runtime interpretation, Just-In-Time (JIT) optimization, or dynamic feature resolution. Unlike conventional JavaScript engines that use speculative JIT compilation, hidden classes, and/or runtime feedback vectors to handle JavaScript's inherent dynamism, this framework enforces a Closed World Assumption (CWA) through a framework-defined statically analyzable semantic subset of JavaScript. Static compilation in at least some embodiments described herein. This enforcement of a CWA through a framework-defined statically analyzable semantic subset of JavaScript is accomplished by one or more of (1) exclusion of dynamic syntax where function declarations/calls, prototype chains, custom objects/arrays, object property access, and ECMAScript Script mode, etc. are explicitly prohibited so as to remove runtime this binding, dynamic dispatch, and implicit global resolution; (2) whitelist of statically resolvable constructs where only let/const, if, for, assignment/binary expressions, and variable identifier whitelists are permitted, and all bindings and control flow edges are known before execution; (3) the “routine” construct described herein replacing “function” where the “routine” construct replaces JS's dynamic function model with a fixed signature, scope-bound code unit that maps directly to WASM func instructions, enabling static call-graph construction and inlining; (4) fail-fast AST validation where syntax and semantic checking traverse the AST node-by-node, and nodes outside the permitted subset abort compilation with an error; or (5) direct WASM/Lowering Pipeline in which validated AST is lowered (e.g., optionally via LLVM-IR) into WASM bytecode without runtime interpreters, dynamic bridges, or fallback mechanisms.

This architectural cohesion reduces the cognitive and technical burden on developers, accelerates deployment cycles, and prevents common integration pitfalls such as memory pointer corruption, asynchronous state desynchronization, and runtime binding failures that frequently compromise conventional WebAssembly implementations, according to at least some embodiments described herein. Consequently, general-purpose computing systems executing these applications benefit from a more efficient resource allocation model, reduced context-switching overhead, and enhanced stability during complex front-end computational workloads, while maintaining full compatibility with existing browser security sandboxes and event loop architectures.

The disclosed techniques collectively overturn a longstanding industry assumption that JavaScript's dynamic architecture and WebAssembly's static execution model are fundamentally incompatible for direct compilation, thereby enabling a novel development paradigm that retains high-level productivity while delivering low-level performance, according to at least some embodiments described herein. Historically, developers facing compute-intensive front-end requirements have been forced to abandon JavaScript entirely in favor of statically-typed languages such as C++, Rust, or Go, which demand specialized toolchains, steep learning curves, and extensive ecosystem migration efforts that significantly increase project complexity and maintenance costs.

The present invention demonstrates that by systematically constraining JavaScript's dynamic features to a rigorously defined statically-analyzable subset, developers can author computation logic using familiar syntax and modern development practices while still producing highly optimized WebAssembly bytecode that executes with deterministic performance characteristics, according to at least some embodiments described herein. This methodological shift eliminates the need for dual-language development workflows, reduces context-switching overhead between disparate programming environments, and enables seamless integration of existing JavaScript libraries through the framework's constrained wrapper architecture, which preserves interoperability without compromising execution predictability.

Unlike alternative approaches that attempt to retroactively optimize unconstrained JavaScript through aggressive just-in-time compilation or speculative execution, the disclosed framework guarantees ahead-of-time determinism by validating structural constraints during the parsing phase and rejecting ambiguous patterns before bytecode generation, thereby preventing runtime deoptimization cascades that degrade user experience in complex web applications, according to at least some embodiments described herein. The framework's pre-deployed architecture further standardizes this optimization pathway across development teams, providing consistent compilation outputs, reproducible performance benchmarks, and predictable memory utilization patterns that are essential for enterprise-grade web deployments.

By reconciling the expressive flexibility of JavaScript with the execution rigor of WebAssembly, the invention delivers a scalable computational model that adapts efficiently to evolving hardware architectures, including multi-core processors, cache-optimized memory subsystems, and heterogeneous execution environments, according to at least some embodiments described herein. This technical advancement not only streamlines front-end development workflows but also elevates the baseline performance ceiling of browser-based applications, enabling general-purpose computing systems to handle increasingly complex computational workloads without requiring specialized hardware acceleration or proprietary runtime extensions, while maintaining backward compatibility with legacy web infrastructure.

The comprehensive integration of fail-fast validation, routine-based code structuring, schema-driven memory optimization, and automated interop bridging establishes a unified compilation pipeline that consistently enhances the operational efficiency of general-purpose computing systems executing web-based applications. Traditional JavaScript transpilation and WebAssembly generation toolchains typically operate in isolated stages, resulting in fragmented optimization opportunities, redundant memory allocations, and unpredictable runtime behavior when dynamic constructs bypass static analysis safeguards. The disclosed method synchronizes these previously disjointed processes into a cohesive framework that enforces structural constraints at the earliest possible stage, enabling the compiler to apply cross-cutting optimizations that propagate deterministically from source code parsing through intermediate representation generation to final WebAssembly bytecode emission, according to at least some embodiments described herein.

This end-to-end static verification eliminates the speculative execution overhead, garbage collection pauses, and dynamic dispatch penalties that characterize conventional JavaScript engines, allowing processors to execute instruction streams with maximal pipeline utilization and minimal branch misprediction rates, according to at least some embodiments described herein. The framework's explicit prohibition of prototype mutation, native method overwriting, and unconstrained function invocation further prevents memory corruption, type confusion, and execution context leakage, which are common sources of security vulnerabilities and performance degradation in loosely constrained web environments. By generating storage layout information that aligns data structures with processor cache hierarchies and memory bus architectures, the invention ensures that data-intensive operations execute with optimal spatial and temporal locality, directly translating to reduced instruction latency and improved throughput on modern multi-core systems.

Unlike fragmented toolchain combinations that require developers to manually coordinate type checkers, bundlers, optimizers, and interop generators, the disclosed framework provides a standardized development environment that automatically harmonizes these components, reducing configuration complexity and eliminating integration inconsistencies that frequently compromise application stability. This architectural standardization, combined with the framework's rigorous compile-time validation and deterministic code generation model, delivers a reproducible performance baseline that scales predictably across diverse hardware configurations, ultimately enabling general-purpose computers to execute complex web applications with the efficiency and reliability traditionally reserved for natively compiled desktop software, while significantly reducing power consumption and thermal throttling during sustained computational workloads, according to at least some embodiments described herein.

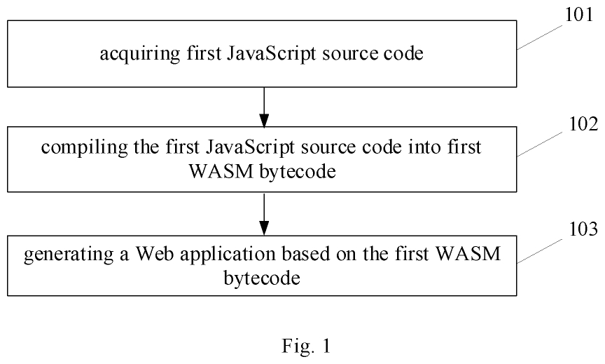

Referring to FIG. 1 which shows a flowchart of an embodiment of development methods for Web applications according to the present disclosure. As shown in FIG. 1, a development method for Web applications includes the following steps:

Step 101, Determine first JavaScript source code. In some embodiments, determining the first JavaScript source code may include receiving (e.g., via pulling or pushing) the first JavaScript source code as an input. In some embodiments, the first JavaScript source code is already existing, and determining the first JavaScript source code may include identifying the pre-existing first JavaScript source code. In some other embodiments where the first JavaScript source code is not yet available, determining the first JavaScript source code may include generating the first JavaScript source code anew or modifying another JavaScript source code into the first JavaScript source code.

In this embodiment, an execution subject (such as a server and/or a terminal device) of the development methods for Web applications may acquire first JavaScript source code. The first JavaScript source code may be a JavaScript-type source code.

In at least some embodiments of the present disclosure, the compilation process of said first JavaScript source code can be completed through static compilation.

Optionally, the above-mentioned execution subject may pre-deploy development frameworks, and perform the above-mentioned development methods by utilizing development frameworks. The pre-deployed development framework is provided to address the limitation that WASM bytecode cannot currently operate independently of JavaScript code in Web or Web-like applications. Therefore, a framework such as a pre-deployed framework described herein is utilized to integrate or wrap the program logic of the Web application(s). The WASM compiled and output by the present disclosure serves as a high-performance program module, which is encapsulated and executed by the pre-deployed framework code in some embodiments. The first JavaScript source code may be code written in a preset development framework, or code written in other code writing tools. That is, for any JavaScript source code of which compilation process is completed through static compilation, the methods provided in this embodiment may implement compiling the JavaScript source code into WASM bytecode and generating Web applications based at least in part on the WASM bytecode.

Optionally, the first JavaScript source code may be code written according to a preset, statically analyzable semantic subset of JavaScript (the statically analyzable semantic subset of JavaScript may provide syntax elements meeting the requirements of static compilation), or code based at least in part on the general JavaScript syntax (dynamic features are constrained in the code).

Step 102, compile said first JavaScript source code into first WASM bytecode.

The JavaScript-type source code may be compiled into a WASM-type target code in at least some embodiments.

As an example, said first JavaScript source code may be converted into an Abstract Syntax Tree (AST).

Optionally, for converting the AST into WAT (WebAssembly Text Format) code, a compilation tool LLVM may be selected to generate LLVM-IR (Low Level Virtual Machine or LLVM Intermediate Representation) code (intermediate code) based at least in part on the above-mentioned AST structure, and after analyzing and optimizing the intermediate code, further output WAT/WASM code required for the operation of Web applications.

Step 103: Generate a Web application based at least in part on said first WASM bytecode.

Web applications may or may not limited to programs loaded in Web browsers running on desktop computers (e.g., personal computers or PCs) and mobile terminal devices (primarily smart phones); browser-related technologies on which Web applications rely are also applied to some dynamically loaded pages in client applications, such as some H5 pages and mini programs.

The first WASM bytecode is executable code for Web browsers, and programs based at least in part on browser-related technologies may run the first WASM bytecode in Web applications.

It shall be noted that with the continuous improvement of the capabilities of Web browsers themselves, the urgent demand of Internet products for hot update capabilities, the substantial improvement of the hardware computing capabilities of user terminals, and the privacy regulations that require part of data have to be stored on user terminal devices (so the programs have to perform computing on these devices), these factors jointly promote the transfer of a lot of computation logic from the server side to the front-end browser in business scenarios. Therefore, the problem of the operating efficiency of code executed in the browser needs to be solved urgently. The Web applications generated based at least in part on said first WASM bytecode proposed in this embodiment may solve the technical problem of the operating efficiency of code executed in the browsers.

It shall be noted that the development methods for Web applications provided in this embodiment may acquire or determine first JavaScript source code, where the compilation process of the first JavaScript source code may be completed through static compilation; compile said first JavaScript source code into first WASM bytecode; generate a Web application based at least in part on said first WASM bytecode. Thus, a novel development method for Web applications is provided. By taking JavaScript-type source code as input, the development threshold and development cycle may be reduced; by limiting the JavaScript-type source code to code that may be compiled through static compilation, the compilation efficiency and execution efficiency may be improved; by taking WASM-type bytecode as execution code, the operating efficiency of code executed in the browsers can be improved. Thus, while the execution efficiency of the developed Web applications may be guaranteed, the development efficiency of Web applications can be improved (saving development costs and shortening the development cycle).

In the related art, JavaScript-type languages extensively use dynamic features. When the front-end computation logic is relatively simple, the problem of low operating efficiency of JavaScript-type languages may be ignored; when the front-end computation logic is relatively complex, the operating efficiency of JavaScript code in the browsers is greatly reduced.

That is, the flexible and dynamic features of JavaScript language also make it difficult to be optimized in the operating performance and efficiency of its code compiled/interpreted and executed on terminal devices. The design of computers at the physical hardware level determines that they are better at processing programs composed of static and definite data structures, while the dynamic syntax of JavaScript language makes it difficult for virtual machine interpreters represented by the Google V8 engine to perform optimization during compilation phase through static analysis technology of programs. The interpreters have to perform dynamic analysis and optimization on the programs based at least in part on means such as feedback vectors during the program runtime phase, which is inefficient in terms of memory utilization and CPU operating efficiency.

Therefore, in the related art, in the scenarios of relatively complex front-end computation logic, a person having ordinary skills in the art usually abandons JavaScript language and use other language types except JavaScript language as input.

It shall be noted that the research on the execution efficiency of code in the browsers in the art is mainly aimed at whether the operating performance of JavaScript can be further improved, and on this issue, a person having ordinary skills in the art usually has the following technical prejudice: limited by the inherent dynamic features of JavaScript language, it is difficult, if not impossible, to achieve a good optimization result on the source program code written in JavaScript language in terms of static analysis and optimization; the use of JavaScript code in the front-end logic computing scenario will reduce performance, and JavaScript code is not suitable to be used as input in this scenario. Moreover, WASM is a technology proposed to replace JavaScript with better operating efficiency and other performance indicators from the very beginning; a person having ordinary skills in the art usually only chooses one of the languages between WASM (or languages compiled into WASM) and JavaScript for development (which is also a technical prejudice).

However, as a language popular for many years, the JavaScript-type language has a wide user base and community ecosystem. Developing Web applications by using JavaScript may shorten the program development cycle and reduce personnel costs.

The technical solutions described in one or more embodiments of the present disclosure, aiming at the problem of low operating performance of JavaScript in scenarios focusing on front-end logic computing, propose technical solutions of compiling JavaScript into WASM bytecode (overcoming the above-mentioned technical prejudices), the high development efficiency feature of JavaScript language and the high operating efficiency and high performance feature of WASM technology are combined, while using JavaScript to develop Web applications to shorten the program development cycle and reduce personnel costs, the performance of Web applications in scenarios with a large number of logic computing is improved.

In some embodiments of the present disclosure, the development methods for Web applications may be performed in development frameworks.

One or more embodiments of the present disclosure propose: realizing static compilation by combining WASM with development framework constraints, thereby optimizing the performance of Web applications; that is, taking constrained JavaScript code as input, compiling the Javascript code into WASM bytecode, and the browsers executing the WASM bytecode to improve operating efficiency.

In some embodiments, said method further includes: performing a checking step on an initial JavaScript source code based at least in part on a preset statically analyzable semantic subset of JavaScript; taking the initial JavaScript source code that passes the checking as the first JavaScript source code.

Said checking step is used to determine whether the compilation process of the initial JavaScript source code can be completed through static compilation in at least some embodiments.

The above-mentioned checking step based at least in part on a statically analyzable semantic subset of JavaScript may be understood as a Closed World Assumption (CWA) mode. In at least some of these embodiments, when an element in the initial JavaScript source code is not in the statically analyzable semantic subset of JavaScript, it is determined to be a failure.

Thus, the checking of whether the compilation process of the initial JavaScript source code may be completed through static compilation may be realized quickly and accurately by means of permitting passage via a whitelist in at least some embodiments.

In contrast, when one or more dynamic features in the initial JavaScript source code are analyzed and checked one by one, and such coding pattern with the risk of dynamic features are intercepted during compilation process, the code implementation of judgment steps will face a huge workload, and some dynamic features may still not be completely analyzed and processed, resulting in differences between the compiled result and the behavior of the original JS source code when executed based at least in part on the standard interpretation mode in at least some embodiments.

In some embodiments, said checking step is based at least in part on a fail-fast mechanism; said method further includes: during the checking process of said checking step, if a to-be-checked point in the initial JavaScript source code fails to pass the checking, then aborting the checking step and displaying an error message; modifying the JavaScript source code according to first editing information input by first user, and continuing to perform said checking step based at least in part on the modified JavaScript source code.

The code point to be checked in the source code may be referred to as the to-be-checked point. Once a to-be-checked point fails to pass the checking, abort the checking immediately and remind the developer (e.g., first user) to modify the initial JS source code in at least some embodiments.

The first editing information input by first user may be used to modify the initial JavaScript source code in at least some embodiments. As an example, after seeing error messages, the developer may modify the error points indicated by the error messages to quickly complete the update of the initial JavaScript source code; based at least in part on updated initial JavaScript source code, the checking step is continued until passing the checking.

It shall be noted that if the checking step adopted by the present disclosure indicates that the checking fails, an error message is displayed, and if an unexpected syntax node is encountered, the compilation process is terminated, so as to expose the problem as early as possible.

In contrast, in the related art, during the code checking process, a blacklist or tolerance strategy is adopted. For some ambiguous coding patterns, as long as they are not in the blacklist or are not particularly serious errors, they are ignored, and the compilation process is completed as much as possible to reduce the blocking of the development process, but some potential problems may be prevented from being exposed and thus enter the production environment program.

It shall be noted that the development methods provided in some embodiments of the present disclosure takes WASM bytecode as target code, and immediately reports an error for the JS coding patterns that may result in failure to compile into WASM bytecode (which may themselves conform to the JS standard syntax but not meet the requirements of static compilation into WASM bytecode), that is, a fail-fast mechanism is adopted. This is completely different from the ideas of general compilers (completing the compilation process as much as possible to reduce the blocking of the development process).

In some embodiments, the statically analyzable semantic subset of JavaScript does not include one or more of the following items: function related information that includes one or more of the following items: function declaration and/or function call; object property access; reference to a custom object; reference to a custom array; or the ECMAScript Script mode.

Function related information (e.g., function) may be understood as all information related to the use of function in at least some embodiments. Functions in the JS syntax have many dynamic features while serving as code reuse modules. As an example, a function in JS may be dynamically created and modified at runtime; the this value of a function is determined at the time of calling rather than at the time of definition; the this value may be dynamically changed by using functions such as call, apply and bind; a function may implement dynamic parameter processing, for example, a function may accept any number of parameters, and dynamic parameters may be accessed through the arguments object or rest parameters; a function is an object, and properties may be dynamically added or deleted; a function also has the dynamicity of prototype and inheritance, and the inheritance relationship may be dynamically changed. In the case that a function in the JS syntax has so many dynamic features, the use of a function will result in that the JS code usually runs in an interpretive execution mode first, and the interpreter may compile some hot code at runtime according to optimization needs (just-in-time compilation), and because of its dynamic features, sometimes the just-in-time compilation effect may instead lead to performance degradation, and the interpreter will also perform deoptimization and re-execute in interpretive mode.

In at least some of the aforementioned embodiments, due to its historical baggage, the JavaScript language includes a great many dynamic features in its functions. To avoid its dynamic features, in the embodiments provided in at least some embodiments of the present disclosure, developers are explicitly restricted from customizing the basic syntax element of function in the statically analyzable semantic subset of JavaScript.

In JS language, Object is or includes a dynamic key-val structure where “which keys are on” a JS object and “what the value corresponding to each key is” can only be confirmed by the interpreter when the code is run to this sentence during interpretation execution. Therefore, it has dynamic features and is difficult to be statically compiled.

In the JS code limited by frameworks, when the use of JS objects is completely prohibited, it will hinder some capabilities implemented by the framework itself. In this case, users may be prohibited from customizing JS objects, and users are allowed to create some framework objects through framework APIs, whose structures are definite and may be statically analyzed. User-created objects (custom objects) make it difficult to determine their accurate structures in the static analysis process due to JS object property access and other reasons.

Arrays in JS inherit objects on the prototype chain, thus resulting in the same dynamic feature problems as objects. In addition, arrays in JS themselves allow dynamic changes to their storage space size, which is more convenient in development but a difficult problem for compiler optimization.

The ECMAScript Script mode introduces implicit global bindings and dynamic scope resolution behaviors that complicate static symbol table construction. The most important effect is that the JS code executed in the script mode makes it difficult to determine the symbol table in the scope of JS during static analysis in the compilation phase.

It shall be noted that the elements that are not included in the statically analyzable semantic subset of JavaScript (may be referred to as whitelist constraint elements) point to code that may lead to dynamic features. Determining these whitelist constraint elements from the JS syntax itself requires combining the coding purpose (e.g., compiling into WASM bytecode) with the JS syntax and semantic features, which requires creative work.

In some embodiments, said statically analyzable semantic subset of JavaScript includes one or more of the following items: a variable identifier whitelist, an assignment expression, a binary expression, a for loop statement, an if conditional statement, a block-scope variable declaration in the form of const, and a block-scope variable declaration in the form of let.

As an example, most expressions include a variable identifier, and a variable identifier whitelist may be provided as the direct identifier name in the expressions; or, after variable name resolution, functions that can be indirectly reached during the static analysis phase and confirmed to be identifiers in the variable identifier whitelist will be executed as expressions, otherwise, an error shall be reported to block the coding pattern in all cases.

In some embodiments, said statically analyzable semantic subset of JavaScript includes a routine, and the routine can be called as a code unit.

In some embodiments, said initial JavaScript source code includes a target routine, and the target routine includes one or more of a routine name, a formal parameter, a logic body, or a return value in at least some embodiments. A routine may be referred to as a code unit, wherein said one or more formal parameters indicate input variables of the routine; said logic body is used to describe computation logic in the execution process of the routine. In one or more embodiments of the present disclosure, while constraining (or prohibiting) functions in JS, a custom code reuse tool is proposed to solve the programming needs of developers. For the convenience of description, the code reuse tool may be referred to as a routine. The concept of routine, which is a new subprogram module, replaces functions, and although developers cannot write custom functions themselves, they may abstract a part of subprograms/submodules for reuse in the overall program in the form of routines.

For a routine, one or more formal parameters and logic body in the routine may include values that may be reached in static analysis in at least some embodiments. Formal Parameters: refer to input variables declared in a function definition, used to accept actual parameters passed from the outside when called; Logic Body: composed of several instructions or statements, describing the specific computation or control logic in the execution process of the routine. A routine may be fully understood by a compiler in the compilation phase and further optimized (including but not limited to compilation mid-end optimization technologies such as inlining optimization).

In some embodiments, a routine has an identifier (routine name), a parameter set (formal parameters), a return value and a syntax structure encapsulating execution logic (logic body), and its main function is to organize a group of program instructions with specific functions or behaviors into an independent and repeatedly callable code unit, thereby realizing the abstraction, modularization and reusability of program logic.

A routine may be executed by other positions in the program in the form of a call in at least some embodiments, and the caller may pass in actual parameter values and receive return results. This structure is usually used to improve the clarity of program structure, reduce code repetition, and support logic encapsulation and hierarchical design.

Optionally, the concept of a routine in the JavaScript source program code will also correspond to the “func” in the compiled and output WASM bytecode. The correspondence herein may include direct correspondence or the following indirect correspondence: in the static analysis process, the source code structure of module A wrapper function B may be optimized through inlining optimization into module A directly including several lines of program code in function B.

In some embodiments, performing the aforementioned checking step on an initial JavaScript source code based at least in part on a preset statically analyzable semantic subset of JavaScript includes: performing a checking step on the input variables and the logic body of the target routine according to said statically analyzable semantic subset of JavaScript.

Thus, it may be ensured that the logic body in the target routine conforms to the statically analyzable semantic subset of JavaScript and can complete the compilation process through static compilation.

As an example, the statically analyzable semantic subset of JavaScript provides a way of code unit reuse based at least in part on a routine. The initial JavaScript source code may include a target routine (a specific routine instance). The above-mentioned checking step may also be performed on the target routine, which is a reusable code unit, based at least in part on a statically analyzable semantic subset of JavaScript.

In some embodiments, said first JavaScript source code includes data structure; wherein said data structure is used to describe one or more of the following items of a data set: fields, types, nested relationships, semantic tags and range transformation information.

The data structure (may be referred to as Schema for example) may provide information describing a data structure.

In one or more embodiments of the present disclosure, a descriptive configuration mechanism for large-scale semi-structured data is provided, which is used to define the fields, types, nested relationships, semantic tags, and their potential variation ranges of data at one time through formal means, for subsequent structure mapping and optimized layout of data in the processes of collection, storage, transmission and conversion.

Thus, in order to improve the transmission efficiency of semi-structured data (such as JS array form) between JS and WASM, the present disclosure describes a data structure format definition (a mechanism which does not exist in the syntax of JS programming language), which may improve the data processing speed during first WASM execution process in at least some embodiments.

In one or more embodiments of the present disclosure, said method further includes: according to said data structure, performing a storage layout optimization step on said data set, and generating storage layout information. Herein, the storage layout information is used represent a layout structure of said data set in a non-transitory storage medium, and the storage layout optimization step includes one or more of the following items: field rearrangement, memory alignment and cache optimization. Thus, the data may be converted into a layout structure conducive to underlying hardware acceleration processing.

In one or more embodiments of the present disclosure, said method further includes: converting said data set into a target format according to said data structure and target format information. Thus, in different application or storage environments, structure mapping and semantic maintenance between multiple formats (such as mutual conversion between JSON and Binary, and mutual conversion between Row and Column) may be realized.

In one or more embodiments of the present disclosure, said method further includes: during the execution process of the first WASM bytecode, reading said data set according to said data structure. Thus, the data set may be read by utilizing the data structure; efficient data transmission is realized, and the operating performance of Web applications is improved. In some embodiments, said performing a checking step on an initial JavaScript source code based at least in part on a preset statically analyzable semantic subset of JavaScript includes: generating an Abstract Syntax Tree according to said initial JavaScript source code, wherein said Abstract Syntax Tree includes a plurality of nodes; performing a syntax checking step on said plurality of nodes according to a preset statically analyzable semantic subset of JavaScript, and performing a semantic checking step on the nodes according to a preset checking rule corresponding to a node type; in response to the syntax checking step failing or the semantic checking step failing, determining that the checking step indicates a failure; in response to the syntax checking step and the semantic checking step both passing, determining that the checking step indicates pass.

In the process of traversing each node on the Abstract Syntax Tree (AST), a judgment is made on each AST node. When the type of the node is within the established range of AST nodes that the program may properly process, corresponding static analysis, code optimization and target code (e.g., WASM bytecode) output are performed on it in at least some embodiments. When the node type is not within the above-mentioned range of AST nodes that can be properly processed (e.g., the statically analyzable semantic subset of JavaScript), it is directly determined as an illegal input according to the idea of Closed World Assumption, and the program reports an error immediately. Developers writing the program may modify the code according to the error message and development document, and then execute the compilation operation again, modify it again if an error is encountered, and so on until the compilation is passed correctly.

In some embodiments, the aforementioned method may further include: determining that the syntax checking fails if the type of the node is not in said statically analyzable semantic subset of JavaScript.

In some embodiments, the aforementioned method may further include: performing a variable identifier checking step on a variable identifier of said first JavaScript source code.

Said variable identifier checking step includes: performing variable name resolution on said target variable identifier, and determining whether said target variable identifier has a statically resolvable binding within the scope according to the resolution result; in response to the target variable identifier having a statically resolvable binding within the scope, determining that the semantic checking passes in at least some embodiments.

Optionally, when a variable is declared, the declared variable is recorded in a symbol table, and the variables in the symbol table are recorded according to scopes. For a variable declared in the code, it may be searched in the symbol table. If it is not found, an error may be reported directly.

It shall be noted that through the variable identifier checking step, it may be avoided that the left value is a variable that cannot be reached through variable name resolution in the processing of symbol table technology and static analysis.

In some embodiments, said method further includes: performing an assignment expression checking step on an assignment expression in said first JavaScript source code.

Optionally, said assignment expression checking step includes: performing said variable identifier checking step on a right value (e.g., R-value comprising an expression, literal, or identifier whose value is being read and assigned) in said assignment expression. Some embodiments may apply a reachable identifier resolution and resolve an R-value at compile time to a definite value or a whitelisted identifier that is fully traceable within a constrained semantic subset to ensure that assigned value(s) is predictable at compile time, eliminate reliance on dynamic runtime evaluation, closure-based late binding, prototype traversal, or implicit type coercion.

Optionally, said assignment expression checking step includes: performing said variable identifier checking step on a left value in said assignment expression; in response to the checking result of said variable identifier checking step being pass, determining whether said left value is a constraint semantic feature element in a preset constrained semantic feature set, wherein said constraint semantic feature element points to a dynamic feature.

In some embodiments, said constrained semantic feature set includes one or more of the following items: a Prototype object, a valueOf native method, a toString native method, and an Eval function call.

In the checking step of the assignment expression, the left value and the right value are processed differently. The right value maintains the principle of reachable identifier resolution. The left value adopts a checking logic different from that of the right value, that is, assignment to a variable (in the form of let) declared in the current scope is allowed, assignment to an identifier beyond this range is not allowed, and the Prototype object is prohibited from being modified, and JS native methods such as valueOf, toString and Eval function calls are prohibited from being overwritten.

It shall be noted that through the assignment expression checking step, the code may be checked from the semantic level, the comprehensiveness and accuracy of the checking are improved, it is ensured that the JS code to be compiled has no dynamic features, and the accurate compilation from JS code to WASM bytecode is realized.

In some embodiments, said Web application includes a second JavaScript source code, and said second JavaScript source code includes a wrapper function for calling said first WASM bytecode.

In the WASM bytecode technical standard of browsers, WASM may be used as an adjunct and supplement to JavaScript code, and in development practice, a WASM program module is usually used as a separate high-performance computing program module for being called by JavaScript code, so that WASM cannot directly operate browser DOM or other APIs (application programming interfaces) related to GUI (graphical user interface) and client capabilities.

As an example, the second JS code first initiates a network request to the server to download the first WASM bytecode, and initializes the first WASM bytecode in the form of a section of memory, acquires a target function from the initialization result object after initialization, a logical entry of the target function defined in the WAT code of the target function, and then outputs its content to the DOM to simulate the view content of the WASM computation result at the UI level in a real business scenario.

Thus, efficient interaction between WASM and the JS code in the business may be realized, thereby realizing the complete and efficient operation of Web applications.

In some embodiments, said method further includes: in response to a debug command, running the initial JavaScript source code, and generating and displaying a running result; receiving second editing information input by a second user, and modifying the JavaScript source code according to the second editing information.

As an example, static checking may be performed on the initial JavaScript source code in the debugging mode, and the code running result in the running environment is simulated. Thus, debugging may be performed on a small amount of code in the process of writing the JavaScript source code, avoiding a large number of errors caused by one-time compilation of a large amount of code.

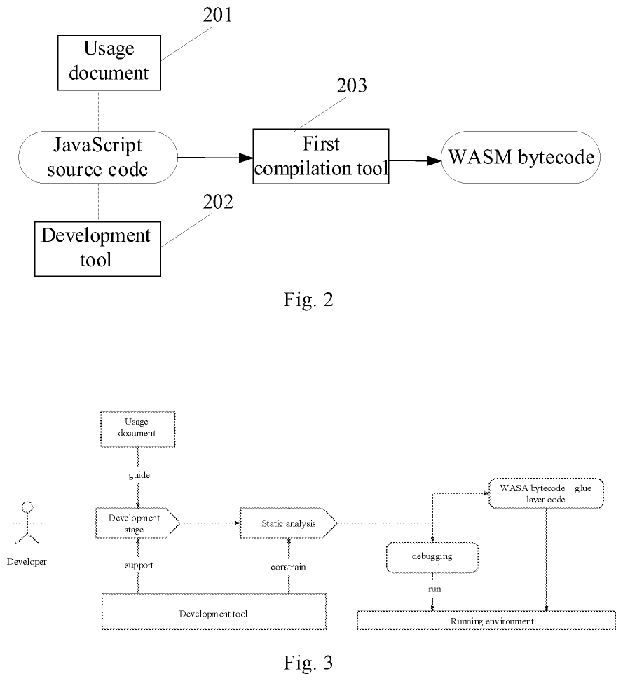

Referring to FIG. 2, which shows a schematic diagram of an embodiment of development frameworks (JavaScript Framework) for Web applications according to the present disclosure. As shown in FIG. 2, the development framework includes: a usage document 201 and a first compilation tool 203.

In at least some of these embodiments illustrated in FIG. 2, the usage document includes a statically analyzable semantic subset of JavaScript. The statically analyzable semantic subset of JavaScript is a proper subset of the standard JS syntax. The statically analyzable semantic subset of JavaScript does not include syntax elements in the JS syntax that may lead to dynamic features.

The first compilation tool may be configured to: perform a checking step on a third JavaScript source code based at least in part on the statically analyzable semantic subset of JavaScript, wherein said checking step is used to determine whether the compilation process of the third JavaScript source code can be completed through static compilation; and compile the third JavaScript source code that passes the checking into a second WASM bytecode.

In some embodiments, said statically analyzable semantic subset of JavaScript does not include one or more of the following items: function related information that includes function declaration and/or function call; object property access; reference to a custom object; reference to a custom array; or ECMAScript Script mode.

In some embodiments, said statically analyzable semantic subset of JavaScript includes one or more of the following items: a variable identifier whitelist, an assignment expression, a binary expression, a for loop statement, an if conditional statement, a block-scope variable declaration in the form of const, or a block-scope variable declaration in the form of let.

In some embodiments, said statically analyzable semantic subset of JavaScript includes a routine, and the routine can be referred to as a code unit. Due to its historical baggage, the JavaScript language includes a great many dynamic features in its functions. To constrain the dynamic features of the code, in at least some embodiments of the present disclosure, developers are explicitly restricted from customizing the basic syntax element of function in the statically analyzable semantic subset of JavaScript.

It shall be noted that the elements which is not included in the statically analyzable semantic subset of JavaScript (may be referred to as whitelist constraint elements) point to code that may lead to dynamic features. Determining these whitelist constraint elements from the JS syntax itself requires combining the coding purpose (e.g., compiling into WASM bytecode) with the JS syntax and semantic features, which requires creative work.

In some embodiments, the present disclosure describes a data structure format definition (may be referred to as Schema for example). It shall be noted that such a data structure format definition is a mechanism that does not exist in the syntax of the JS programming language. As an example, the framework provides a descriptive configuration mechanism for large-scale semi-structured data, which is used to define the fields, types, nested relationships, semantic tags and their potential variation ranges of data at one time through formal means, for subsequent structure mapping and optimized layout of data in the processes of collection, storage, transmission and conversion.

Thus, to improve the transmission efficiency of semi-structured data (such as the JS object array form) between JS and WASM, the data processing speed during first WASM execution process may be improved. Optionally, the above-mentioned development framework includes a development tool 202. The development tool 202 may provide an interface environment for writing JavaScript source code, and may display the displayed JavaScript source code in different ways according to different types.

Optionally, the present disclosure proposes a development framework, which may be adapted to the description of the computation logic of large-scale data in front-end intensive computing scenarios. The framework provides usage documents and compilation tools to constrain and guide developers, constrain the use of dynamic features of the JavaScript language (these dynamic features are obstacles to performance optimization), and guide them to develop logic descriptions closer to the computer hardware level.

The development frameworks proposed in at least some embodiments of the present disclosure may be adapted to the operation mode of debugging, and the JS code in this mode may be debugged by the browser DevTool (which is conducive to improving the development efficiency of development based at least in part on framework). As an example, the debugging tool is provided by the browser.

The development frameworks proposed in at least some embodiments of the present disclosure may compile the JavaScript source program code that complies with the framework constraints into WASM bytecode.

The development frameworks proposed in at least some embodiments of the present disclosure may include external connection code (e.g., a glue layer), and the external framework connection code is used to connect the WASM bytecode with the external framework, and/or the external framework connection code is used to connect the WASM bytecode with other business logic code in Web applications. For example, the second JavaScript source code in at least some embodiments of the present disclosure.

Development frameworks or programs in the prior art make extensive use of dynamic features, resulting in difficulty in static analysis and optimization.

In the development stage, the development frameworks proposed in at least some embodiments of the present disclosure guides and constrains the process of developers writing business logic code through usage documents, so that the source code is code suitable for performance optimization for computer hardware, and avoids the use of dynamic features in the JavaScript syntax; the development difficulty of Web applications is reduced and the development cycle is shortened, and meanwhile, WASM bytecode is output, and the browser runs the WASM bytecode to improve the browser running efficiency.

As described above, the present disclosure proposes solutions such as delimiting a subset (whitelist) within the JavaScript language standard as a secure scope, implementing static compilation for the said subset and outputting WASM. Herein, the scope of the said subset is described through a specific example, wherein a formal definition of a JavaScript language subset is provided and the said definition is made by adopting the method of Operational Semantics, which is one of the three major methods in the field of formal semantics of programming languages. The said example can serve as a minimal example to prove that the present invention is technically feasible and implementable.

Referring to FIG. 3, which shows a schematic diagram of an application scenario of the development framework.

The framework provides usage documents to guide and constrain the process of developers writing business logic code.

In the development stage, developers may use development tools to write JavaScript source code.

In the static analysis stage, the development framework may perform a checking step on initial JavaScript source code based at least in part on a preset statically analyzable semantic subset of JavaScript, wherein said checking step is used to determine whether the compilation process of the initial JavaScript source code can be completed through static compilation; and take the initial JavaScript source code that passes the checking as the first JavaScript source code. If the checking is not passed, the developer adjusts the initial JavaScript source code until it passes the checking.

In the debugging state, the JavaScript source code that has passed the static analysis may be run to check whether the business logic of the JavaScript source code is correct in at least some embodiments.

In the compilation state, the JavaScript source code that has passed the static analysis is compiled into WASM bytecode. The WASM bytecode may be called by a glue layer to realize running in the browser running environment in at least some embodiments.

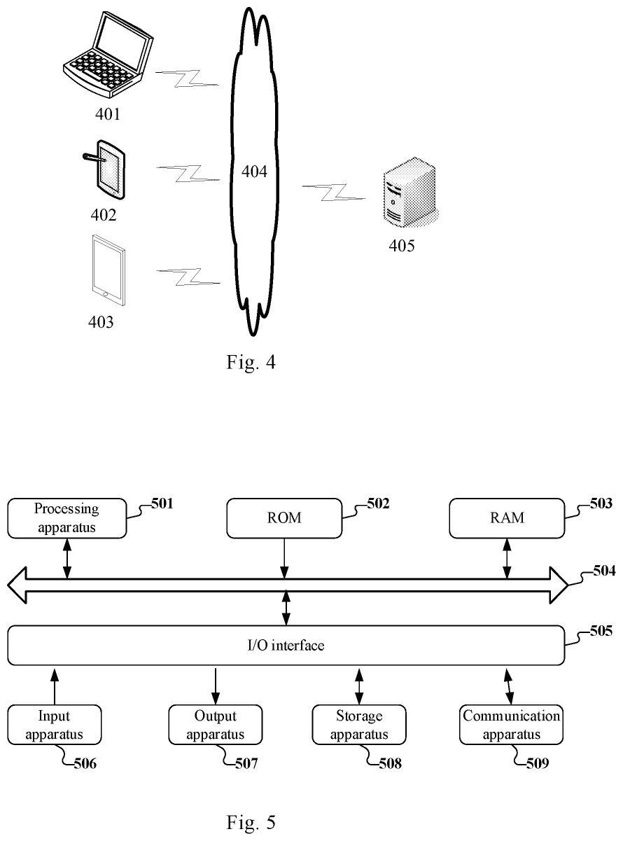

Referring to FIG. 4, which shows an exemplary system architecture to which the development methods and development frameworks for Web applications of an embodiment of the present disclosure may be applied.

As shown in FIG. 4, the system architecture may include terminal devices 401, 402, 403, a network 404, and a server 405. The network 404 is used to provide a medium for communication links between the terminal devices 401, 402, 403 and the server 405. The network 404 may include various connection types, such as wired, wireless communication links, or optical fiber cables, and the like in at least some embodiments.

The terminal devices 401, 402, 403 may interact with the server 405 through the network 404 to receive or send messages and the like. Various client applications may be installed on the terminal devices 401, 402, 403, such as a web browser application, a search application, a news information application in at least some embodiments. The client applications in the terminal devices 401, 402, 403 may receive user instructions and complete corresponding functions according to the user instructions, such as adding corresponding information to the information according to the user instructions.

The terminal devices 401, 402, 403 may be hardware or software. When the terminal devices 401, 402, 403 are hardware, they may be various electronic devices with a display screen and supporting web browsing, including but not limited to smart phones, tablet computers, e-book readers, MP3 (Moving Picture Experts Group Audio Layer III) players, MP4 (Moving Picture Experts Group Audio Layer IV) players, laptop portable computers and desktop computers, and the like. When the terminal devices 401, 402, 403 are software, they may be installed in the electronic devices listed above. They may be implemented as a plurality of software or software modules (for example, software or software modules for providing distributed services), or as a single software or software module. No specific limitation is made herein.

The server 405 may be a server that provides various services, for example, receiving information acquisition requests sent by the terminal devices 401, 402, 403, and acquiring display information corresponding to an information acquisition request through various means according to the information acquisition request. And sending data related to the display information to the terminal devices 401, 402, 403.

It shall be noted that the development methods for Web applications provided by the embodiments of the present disclosure may be performed by a terminal device, and the development frameworks may be deployed on a terminal device. Correspondingly, the development methods and development frameworks for Web applications may be provided in the terminal devices 401, 402, 403. In addition, the development methods and development frameworks for Web applications provided by the embodiments of the present disclosure may also be performed by the server 405. Correspondingly, the development methods and development frameworks for Web applications may be provided in the server 405.

It shall be understood that the numbers of terminal devices, networks, and servers in FIG. 4 are merely illustrative. There may be any number of terminal devices, networks, and servers according to implementation needs.

Referring to FIG. 5, which shows a schematic diagram of a structure of an electronic device (for example, a terminal device or server in FIG. 4) suitable for implementing the embodiments of the present disclosure. The terminal devices in the embodiments of the present disclosure may include, but are not limited to, mobile terminals such as mobile phones, notebook computers, digital broadcast receivers, PDAs (Personal Digital Assistants), PADs (Tablet Computers), PMPs (Portable Multimedia Players), vehicle-mounted terminals (for example, vehicle-mounted navigation terminals), and the like, and fixed terminals such as digital TVs, desktop computers, and the like. The electronic device shown in FIG. 5 is merely an example, and shall not bring any limitation to the functions and the scope of use of the embodiments of the present disclosure.

As shown in FIG. 5, the electronic device may include a processing apparatus (for example, a Central Processing Unit, a Graphics Processing Unit, etc.) 501, which may execute various appropriate actions and processes according to a program stored in a Read-Only Memory (ROM) 502 or a program loaded from a storage apparatus 508 into a Random Access Memory (RAM) 503. In the RAM 503, various programs and data required for the operation of the electronic device 500 are also stored. The processing apparatus 501, the ROM 502, and the RAM 503 are connected to each other via a bus 504. An Input/Output (I/O) interface 505 is also connected to the bus 504.

Generally, the following apparatuses may be connected to the I/O interface 505: input apparatuses 506 including, for example, a touch screen, a touch pad, a keyboard, a mouse, a camera, a microphone, an accelerometer, a gyroscope, and the like; output apparatuses 507 including, for example, a Liquid Crystal Display (LCD), a speaker, a vibrator, and the like; storage apparatuses 508 including, for example, a magnetic tape, a hard disk, and the like; and communication apparatuses 509. The communication apparatus 509 may allow the electronic device to communicate with other devices wirelessly or by wire to exchange data. Although FIG. 5 shows an electronic device with various apparatuses, it shall be understood that not all of the shown apparatuses are required to be implemented or provided. Alternatively, more or less apparatuses may be implemented or provided.

In particular, according to the embodiments of the present disclosure, the processes described above with reference to the flowcharts may be implemented as a computer software program. For example, the embodiments of the present disclosure include a computer program product, which includes a computer program carried on a non-transitory computer-readable medium, the computer program including program code for performing the methods shown in the flowcharts. In such embodiments, the computer program may be downloaded and installed from a network via the communication apparatus 509, or installed from the storage apparatus 508, or installed from the ROM 502. When the computer program is executed by the processing apparatus 501, the above-mentioned functions defined in the methods of the embodiments of the present disclosure are performed.

It shall be noted that the above-mentioned computer-readable medium in at least some embodiments of the present disclosure may be a computer-readable signal medium or a computer-readable storage medium, or any combination of the two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination of the above. In at least some embodiments of the present disclosure, the computer-readable storage medium may be any tangible medium that contains or stores a program, which may be used by or in connection with an instruction execution system, apparatus, or device. In at least some embodiments of the present disclosure, the computer-readable signal medium may include a data signal propagated in baseband or as part of a carrier wave, carrying computer-readable program code. Such a propagated data signal may take various forms, including but not limited to an electromagnetic signal, an optical signal, or any suitable combination of the above. The computer-readable signal medium may also be any computer-readable medium other than a computer-readable storage medium, and the computer-readable signal medium may send, propagate, or transmit a program for use by or in connection with an instruction execution system, apparatus, or device. The program code contained on the computer-readable medium may be transmitted by any suitable medium, including but not limited to a wire, an optical fiber cable, RF (Radio Frequency), etc., or any suitable combination of the above.

In some implementations, the client and the server may communicate using any currently known or future developed network protocol, such as HTTP (Hypertext Transfer Protocol), and may be interconnected with any form or medium of digital data communication (for example, a communication network). Examples of communication networks include a local area network (“LAN”), a wide area network (“WAN”), internet work (for example, the Internet), and peer-to-peer networks (for example, ad hoc peer-to-peer networks), as well as any currently known or future developed networks.

The electronic device shown in FIG. 5 may include: one or more processors; a storage apparatus, configured to store one or more programs; when said one or more programs are executed by said one or more processors, such that said one or more processors implement: acquiring a first JavaScript source code, wherein the compilation process of said first JavaScript source code is completed through static compilation; compiling said first JavaScript source code into a first WASM bytecode; and generating a Web application based at least in part on said first WASM bytecode.

In some embodiments, said method further includes: performing a checking step on an initial JavaScript source code based at least in part on a preset statically analyzable semantic subset of JavaScript, wherein said checking step is used to determine whether the compilation process of the initial JavaScript source code can be completed through static compilation; and taking the initial JavaScript source code that passes the checking as the first JavaScript source code.

In some embodiments, said method further includes: during the performance of checking of said checking step, if a to-be-checked point in the initial JavaScript source code fails to pass the checking, then aborting the checking step and displaying an error message; said checking step is based at least in part on a fail-fast mechanism; and modifying the JavaScript source code according to first editing information input by first user, and continuing to perform said checking step based at least in part on the modified JavaScript source code.

In some embodiments, said statically analyzable semantic subset of JavaScript does not include one or more of the following items: function related information, wherein the function related information includes one or more of the following items: function declaration, function call; object property access; reference to a custom object; reference to a custom array; ECMAScript Script mode.

In some embodiments, said statically analyzable semantic subset of JavaScript further includes one or more of the following items: a variable identifier whitelist, an assignment expression, a binary expression, a for loop statement, an if conditional statement, a block-scope variable declaration in a const manner, a block-scope variable declaration in a let manner.

In some embodiments, said statically analyzable semantic subset of JavaScript includes a routine, the routine can be called as a code unit; said initial JavaScript source code includes a target routine, the target routine includes a routine name, a formal parameter, a logic body and a return value; wherein said formal parameters indicate input variables of the routine; said logic body is used to describe computation logic in the execution process of the routine.

In some embodiments, said performing a checking step on an initial JavaScript source code based at least in part on a preset statically analyzable semantic subset of JavaScript includes: performing a checking step on the input variables and the logic body of the target routine according to said statically analyzable semantic subset of JavaScript.

In some embodiments, said first JavaScript source code includes data structure; wherein said data structure is used to describe one or more of the following items of a data set: fields, types, nested relationships, semantic tags and range transformation information.

In some embodiments, said method further includes one or more of the following items: according to said data structure, performing a storage layout optimization step on said data set, and generating storage layout information, wherein the storage layout information is used to represent a layout structure of said data set in a storage medium, the storage layout optimization step includes one or more of the following steps: field rearrangement, memory alignment, cache optimization; converting said data set into a target format according to said data structure and target format information; during the execution process of the first WASM bytecode, reading said data set according to said data structure.

In some embodiments, said performing a checking step on an initial JavaScript source code based at least in part on a preset statically analyzable semantic subset of JavaScript includes: generating an Abstract Syntax Tree according to said initial JavaScript source code, wherein said Abstract Syntax Tree includes a plurality of nodes; performing a syntax checking step on said plurality of nodes according to a preset statically analyzable semantic subset of JavaScript, and performing a semantic checking step on the nodes according to a preset checking rule corresponding to the node types; in response to the syntax checking step failing or the semantic checking step failing, determining that the checking step indicates a failure; in response to the syntax checking step and the semantic checking step both passing, determining that the checking step indicates a pass.

In some embodiments, said syntax checking step includes: determining that the syntax checking fails if the type of the node is not in said statically analyzable semantic subset of JavaScript.

In some embodiments, said semantic checking step includes: performing a variable identifier checking step on a variable identifier of said first JavaScript source code; wherein said variable identifier checking step includes: performing variable name resolution on said target variable identifier, and determining whether said target variable identifier has a statically resolvable binding within the scope according to the resolution result; in response to the target variable identifier having a statically resolvable binding within the scope, determining that the semantic checking passes.

In some embodiments, said semantic checking step includes: performing an assignment expression checking step on an assignment expression in said first JavaScript source code; wherein said assignment expression checking step includes: performing said variable identifier checking step on a right value in said assignment expression; performing said variable identifier checking step on a left value in said assignment expression; in response to the checking result of said variable identifier checking step being a pass, determining whether said left value is a constraint semantic feature element in a preset constraint semantic feature set, wherein said constraint semantic feature element points to a dynamic feature.

In some embodiments, said constraint semantic feature set includes one or more of the following items: a Prototype object, a valueOf native method, a toString native method, and an Eval function call.

In some embodiments, said Web application includes a second JavaScript source code, said second JavaScript source code includes a wrapper function for calling said first WASM bytecode.

In some embodiments, said method further includes: in response to a debugging instruction, running the initial JavaScript source code, generating and displaying a running result; receiving second editing information input by a second user, and modifying the JavaScript source code according to the second editing information.

The above-mentioned computer-readable medium may be included in the above-mentioned electronic device; or may exist separately without being assembled into the electronic device.

The above-mentioned computer-readable medium carries one or more programs, and when said one or more programs are executed by the electronic device, the electronic device is caused to: acquire a first JavaScript source code; compile said first JavaScript source code into a first WASM bytecode; and generate a Web application based at least in part on said first WASM bytecode.

The flowcharts and block diagrams in the drawings illustrate the architecture, functionality, and operation that may be implemented by the systems, methods, and computer program products according to various embodiments of the present disclosure. In this regard, each block in the flowcharts or block diagrams may represent a module, program segment, or part of code, which includes one or more executable instructions for implementing the specified logical functions. It shall also be noted that, in some alternative implementations, the functions noted in the block may occur out of the order noted in the drawings. For example, two blocks shown in succession may, in fact, be executed substantially in parallel, or they may sometimes be executed in the reverse order, depending upon the functionality involved. It shall also be noted that each block of the block diagrams and/or flowcharts, and combinations of blocks in the block diagrams and/or flowcharts, may be implemented by special-purpose hardware-based systems that perform the specified functions or operations, or may be implemented by combinations of special-purpose hardware and computer instructions.

The tools described in the embodiments of the present disclosure may be implemented in the form of software, or be implemented in the form of hardware. Wherein the names of the tools do not constitute a limitation on the unit itself in some cases.

The functions described hereinabove may be performed at least in part by one or more hardware logic components. For example, and without limitation, illustrative types of hardware logic components that may be used include: Field-Programmable Gate Arrays (FPGA), Application-Specific Integrated Circuits (ASIC), Application-Specific Standard Products (ASSP), System on Chips (SOC), Complex Programmable Logic Devices (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based at least in part on one or more wires, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination of the foregoing.

The above description is only preferred embodiments of the present disclosure and an illustration of the applied technical principles. A person having ordinary skills in the art shall understand that the scope of the disclosure involved in at least some embodiments of the present disclosure is not limited to the technical solution formed by the specific combination of the above technical features, but also covers other technical solutions formed by any combination of the above technical features or their equivalent features without departing from the above disclosure concept. For example, a technical solution formed by replacing technical features disclosed in at least some embodiments of the present disclosure (but not limited to) having similar functions with the above features.

In addition, although the operations are depicted in a specific order, this shall not be understood as requiring that the operations be performed in the specific order shown or in sequential order. In certain circumstances, multitasking and parallel processing may be advantageous. Similarly, although several specific implementation details are included in the above discussion, these shall not be construed as limiting the scope of the present disclosure. Certain features that are described in the context of separate embodiments may also be implemented in combination in a single embodiment. Conversely, various features that are described in the context of a single embodiment may also be implemented separately or in any suitable sub-combination in a plurality of embodiments.

Although the subject matter has been described in language specific to structural features and/or methodological acts, it is to be understood that the subject matter defined in the appended claims is not necessarily limited to the specific features and acts described above. Rather, the specific features and acts described above are merely example forms of implementing the claims.

We claim:

1. A development method for Web applications, comprising:
determining first JavaScript source code, wherein a compilation process to be performed on said first JavaScript source code is to be completed through static compilation;
performing the compilation process on said first JavaScript source code into first WebAssembly (WASM) bytecode; and
generating a Web application based at least in part on said first WASM bytecode.

2. The method according to claim 1, characterized in that said method further includes:
performing a checking step on an initial JavaScript source code based at least in part on a preset that comprises a statically analyzable semantic subset of JavaScript, wherein said checking step is used in a determination of whether the compilation process of the initial JavaScript source code can be completed through the static compilation; and
identifying the initial JavaScript source code that passes the checking as the first JavaScript source code.

3. The method according to claim 2, characterized in that said checking step is based at least in part on a fail-fast mechanism, wherein said method further includes:
during said checking step, when a to-be-checked point in the initial JavaScript source code fails to pass the checking step, aborting the checking step and displaying an error message; and
modifying the initial JavaScript source code into modified initial JavaScript based at least in part upon first editing information provided by first user; and
continuing execution of said checking step based at least in part on the modified initial JavaScript source code.

4. The method according to claim 2, characterized in that said statically analyzable semantic subset of JavaScript does not include one or more of:
function related information that includes a function declaration or a function call,
an object property access,
a reference to a custom object,
a reference to a custom array, or
an ECMAScript Script mode.

5. The method according to claim 2, characterized in that said statically analyzable semantic subset of JavaScript further includes one or more of:
a variable identifier whitelist,
an assignment expression,
a binary expression,
a FOR loop statement,
an if conditional statement,
a block-scope variable declaration in a first form of const, or
a block-scope variable declaration in a second form of let.

6. The method according to claim 2, characterized in that said statically analyzable semantic subset of JavaScript includes a routine or a code unit, wherein
said initial JavaScript source code includes a target routine, one or more formal parameter, a logic body, and a return value, the target routine associated with a routine identifier,
said one or more formal parameters indicate one or more input variables of the routine, and
said logic body is used to describe computation logic in the execution process of the routine.

7. The method according to claim 6, characterized in that performing the checking step on the initial JavaScript source code based at least in part on the preset statically analyzable semantic subset of JavaScript includes:
performing a first checking step on the one or more input variables and the logic body of the target routine based at least in part upon said statically analyzable semantic subset of JavaScript.

8. The method according to claim 1, characterized in that said first JavaScript source code includes a data structure, wherein the data structure comprises data or information that describes one or more characteristics of a data set or data therein, and the one or more characteristics comprise one or more fields, one or more types, one or more nested relationships, one or more semantic tags, or range transformation information.

9. The method according to claim 8, characterized in that said method further includes one or more of:
based at least in part upon said data structure, performing a storage layout optimization step on said data set; and
generating storage layout information, wherein
the storage layout information represents at least a layout structure of said data set in a non-transitory storage medium, and
the storage layout optimization step includes one or more of: a field rearrangement operation, a memory alignment operation, a cache optimization operation;
converting said data set into a target format based at least in part upon said data structure and information about the target format;
during execution of the first WASM bytecode, reading said data set based at least in part upon said data structure.

10. The method according to claim 2, characterized in that performing the checking step on the initial JavaScript source code based at least in part on the preset statically analyzable semantic subset of JavaScript includes:
generating an Abstract Syntax Tree based at least in part upon said initial JavaScript source code, wherein said Abstract Syntax Tree includes a plurality of nodes;
performing a syntax checking step on said plurality of nodes based at least in part upon the preset statically analyzable semantic subset of JavaScript;
performing a semantic checking step on at least some of the plurality of nodes based at least in part upon a preset checking rule that corresponds to one or more types of the at least some of the plurality of nodes;
in response to an error during the syntax checking step or the semantic checking step, determining that the checking step indicates a failure;
in response to successful completion of both the syntax checking step and the semantic checking step, determining that the checking step indicates a success.

11. The method according to claim 10, characterized in that said syntax checking step includes:
determining that the syntax checking step fails when one or more types of the at least some of the plurality of nodes are not in said statically analyzable semantic subset of JavaScript.

12. The method according to claim 10, characterized in that said semantic checking step includes:
performing a variable identifier checking step on a variable identifier of said first JavaScript source code, wherein said variable identifier checking step includes:
performing variable name resolution on said variable identifier;
determining whether said variable identifier includes a statically resolvable binding within a scope based at least in part upon a result of the variable name resolution; and
in response to a determination that the variable identifier includes the statically resolvable binding within the scope, determining that the semantic checking step passes.

13. The method according to claim 12, characterized in that said semantic checking step includes:
performing an assignment expression checking step on an assignment expression in said first JavaScript source code, wherein said assignment expression checking step includes:
performing said variable identifier checking step on an R-value for said assignment expression;
performing said variable identifier checking step on an L-value for said assignment expression; and
in response to a success of performing the variable checking step on said variable identifier, determining whether said L-value comprises a constraint semantic feature element in a preset constraint semantic feature set, wherein said constraint semantic feature element points or links to a dynamic feature.

14. The method according to claim 13, characterized in that said preset constraint semantic feature set includes one or more of a prototype object, a valueOf native method, a toString native method, and an Eval function call.

15. The method according to claim 1, characterized in that said Web application includes a second JavaScript source code, wherein said second JavaScript source code includes a wrapper function which, when executed, calls said first WASM bytecode.

16. The method according to claim 2, characterized in that said method further includes:
in response to a debug command,
executing the initial JavaScript source code; and
generating and displaying an execution result;
receiving second editing information provided by a second user; and
modifying the initial JavaScript source code based at least in part upon the second editing information.

17. The method according to claim 1, characterized in that said method is performed in a pre-deployed development framework into which a plurality of WebAssembly bytecodes are wrapped and logically linked.

18. A development framework for Web applications, comprising:
a data structure storing thereupon usage data and a statically analyzable semantic subset of JavaScript; and
a first compilation sub-system which, when executed, performs a set of acts, the set of acts comprising:
executing a checking step on a third JavaScript source code based at least in part on the statically analyzable semantic subset of JavaScript, wherein
said checking step, when executed, determines whether a compilation process performed on the third JavaScript source code can be successfully completed through static compilation;
in response to determining that the compilation process will pass the checking step, performing the compilation process on the third JavaScript source code to transform the third JavaScript code into a second WASM bytecode.

19. The development framework according to claim 18, characterized in that
said statically analyzable semantic subset of JavaScript does not include one or more of:
function related information that includes at least one of a function declaration or a function call;
object property access;
a first reference to a custom object;
a second reference to a custom array; or
a ECMAScript Script mode;
said statically analyzable semantic subset of JavaScript includes one or more of:
a variable identifier whitelist;
an assignment expression;
a binary expression;
a FOR loop statement;
an IF conditional statement;
a block-scope variable declaration in the form of const; or
a block-scope variable declaration in the form of let; or
said statically analyzable semantic subset of JavaScript includes:
a routine, wherein the routine is characterized by being capable of being called as a code unit;
initial JavaScript source code includes a target routine, wherein the target routine includes a routine name;
one or more formal parameters;
a logic body; and
a return value, wherein
said one or more formal parameters indicate one or more input variables of the routine, and
said logic body is used to describe computation logic in the execution process of the routine.

20. A computer program product comprising a non-transitory computer readable storage medium storing thereupon a sequence of instructions which, when executed by a microprocessor, causes the microprocessor to execute a set of acts, the set of acts comprising:
determining first JavaScript source code, wherein a compilation process to be performed on said first JavaScript source code is to be completed through static compilation;
performing the compilation process on said first JavaScript source code into first WebAssembly (WASM) bytecode; and
generating a Web application based at least in part on said first WASM bytecode.
